(19) United States
(12) Patent Application Publication
(10) Pub. No.: US 2007/0130750 A1
(43) Pub. Date: Jun. 14, 2007

(54) Method of providing a seat back involving the use of a design manikin

(76) Inventors: Mari C. Milosic, Grosse Pointe Park, MI (US); Stephen M. Becker, Ypsilanti, MI (US); Wendy M. Pewinski, Westland, MI (US)

Correspondence Address: CLARK HILL, P.C., 500 WOODWARD AVENUE, SUITE 3500, DETROIT, MI, 48226, US

(21) Appl. No.: 10/581,768

(22) PCT Filed: Dec. 22, 2004
(86) PCT No.: PCT/CA04/02177

§ 371 Date: Jun. 6, 2006

Related U.S. Application Data
(60) Provisional application No. 60/532,771, filed on Dec. 23, 2003.

(51) Int. Cl. B23P 17/04

(52) U.S. Cl. 29/592

(57) ABSTRACT

A method of providing a seat back (17) of a seat assembly including shape defining steps that involve the use of a design manikin (14). A contour of the centerline (15) for the seat back is determined according to a hip point (10), or ‘h-point,’and a torso line (12) of the manikin. The determination includes definition of a lumbar apex reference point (16) above the hip point along the torso line, a lumbar shape reference circle (40) defined as being behind the torso line and spaced apart therefrom, a forward lumbar prominence line (30) which is parallel to the torso line and tangential to the lumbar shape reference circle, and a rearward lumbar prominence (20) line which is parallel to and rearward of the forward lumbar prominence line.

### 1. FIELD OF THE INVENTION

This invention relates to a method of designing seating assemblies, and more particularly, to a process for designing the contours for the seat back of a seating assembly for maximum occupant support and comfort.

### 2. DESCRIPTION OF THE RELATED ART

Seat design has become increasingly important with respect to the design of automobiles as engineers attempt to design seating assemblies that are both safe and comfortable, however, consumers are commonly dissatisfied with automobile seat comfort, or lack thereof. Upon close analysis, the most highly ranked dissatisfaction is with poor or uncomfortable lumbar support. These dissatisfactions refer to either the lumbar mechanism or the lower back seating contour or both.

The greatest challenge engineers face when designing seats has to do with the multitudes of different body sizes and shapes. When designing seats, a supplier typically samples the complete population with respect to both morphology (shape) and anthropometry (structure), in order to have representative models for use in seat design. It is important when designing seat backs to also consider the specific structure of the spinal column, since the inherent structure of the spinal column is consistent over the entire population.

The spinal column has a specific number of vertebrae—a taller person does not have more vertebrae, but instead has bigger vertebrae. The placement of a person's vertebrae dictates that person's lumbar curve, or lordosis. The length of this curve depends on the torso length of the particular individual, meaning the apex of this curve can vary from person to person by an amount up to about 120 mm. This means that designing a seat back to accommodate such a varying population becomes challenging at best. There is a need in the art for a method of better designing the curvature of a seat back to accommodate and be comfortable for a significant portion of the population.

The invention uses an inside-out design methodology, which considers an occupant to the seat rather than the seat to the occupant, and anatomical landmarks of the occupant to support the lower back. This is an alternate approach to the more common lumbar support concept. This alternate approach allows a designer to design a seat back based on cross-sectional human dimensions (transverse plane), rather than longitudinal dimensions (saggital plane). This design also offers a larger surface contact area (the pelvis) rather than the traditional lumbar (lumbar spine area). In addition, the present invention assists in controlling dynamic effects (micro motions) transferred to the spinal muscles (erector spinae) that are associated with road vibration transmissions. These vibration transmissions elicit a rapid firing of the spinal muscles ultimately leading to muscle fatigue condition and thus, discomfort.

### SUMMARY OF THE INVENTION

According to one aspect of the invention, a method for shaping a centerline for a seat back of a seat assembly is provided. The process involves the use of a design manikin having a hip point and a torso line. The method defines a lumbar apex reference point above the hip point along the torso line. A lumbar shape reference circle defined as being behind the torso line and spaced apart therefrom. A forward lumbar prominence line is created parallel to the torso line and tangential to the lumbar shape reference circle. A rearward lumbar prominence line, which is parallel to the forward lumbar prominence line, is created and spaced reward from the forward lumbar prominence line. A centerline is then shaped for the seat back, wherein the centerline incorporates the forward and rearward lumbar prominence lines and the lumbar shape reference circle.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a plan view of a design manikin with the hip point and torso line determined as explained in the process below;

FIG. 2 is a plan view of the torso of a design manikin with various construction shapes used to determine the contours of a seat back as described in the process;

FIG. 3 is a plan view of the construction of a apex horizontal contour;

FIG. 4 is a plan view of the construction of a lower horizontal seat back contour;

FIG. 5 is a plan view of the construction of an upper horizontal contour;

FIG. 6 is a plan view of the construction of the middle seat back bolster contour;

FIG. 7 is a plan view of the construction of the upper seat back bolster contour;

FIG. 8 is a plan view of the overall seat back contours as constructed in the process as described herein; and

FIG. 9 is a perspective view of a seat assembly inside a motor vehicle, partially cut away.

### DETAILED DESCRIPTION OF THE PREFERRED EMBODIMENT

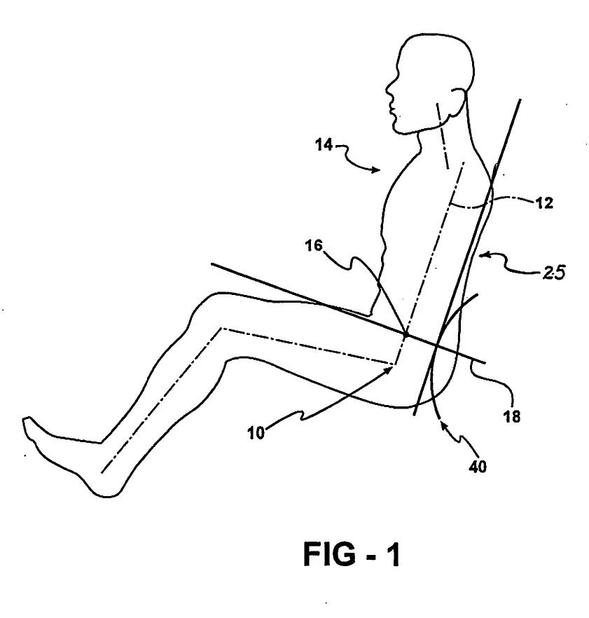

Referring to FIG. 1, the process of developing seat contours incorporates a design process taken from the perspective of the occupant. To this end, parameters of a design manikin 14 are required. More specifically, a hip point 10 (“Hpt”) and a torso line 12 of the design manikin 14 must be known. The parameters of the design manikin 14 are chosen based on a particular vehicle environment in which the seat assembly is to be located. Once these reference parameters have been defined, the method can then begin the construction of the seat back contour that will optimally support the full range of intended occupants.

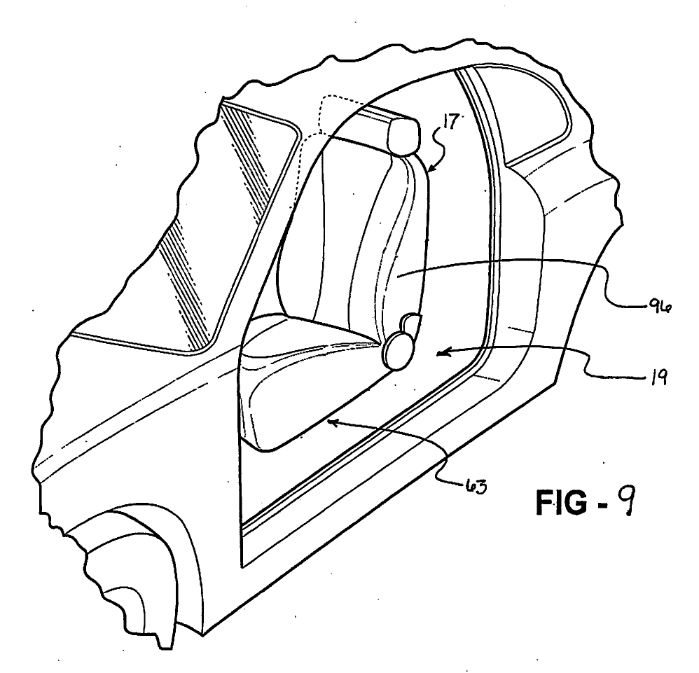

The first main step of the method is to determine a centerline 15 of a seat back 17, best seen in FIG. 9. The centerline 15 is the relatively vertical line (usually rotated rearward relative to vertical based on the intended design recline angle of the seat, which varies according to the goal of the design, and is generally parallel to the design manikin torso line) of the seat back 17. The centerline 15 will determine a contour of the seat back 17 which will be the basis of how a seat assembly 19 incorporating the seat back 17 will support its occupants.

Determining the Lumbar Support Shape with a Lumbar Centerline Contour

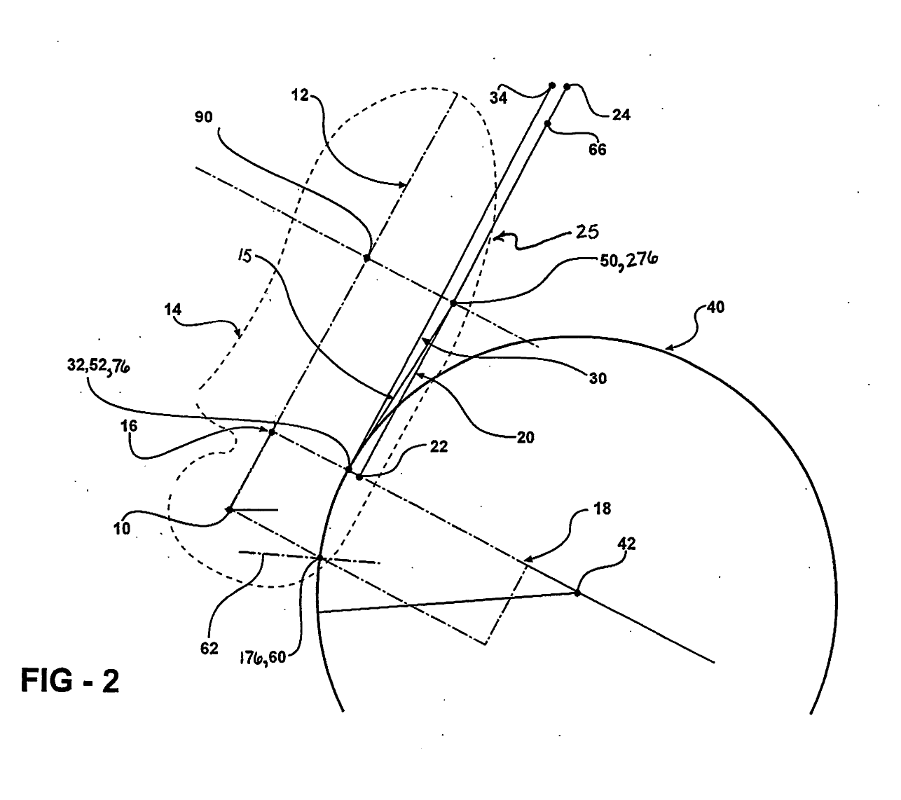

Referring to FIG. 2, and because the Hpt 10 and torso line 12 of the design manikin 14 have been defined, the next step is to create the proper lumbar support shape based on the proper lumbar apex location and surface radius in this region. This is accomplished by constructing a lumbar apex reference point 16 vertically upward from the Hpt 10 along the torso line 12 a specified distance based on anthropometric landmarks. Using the lumbar apex reference point 16 as the origin, a rearward lumbar apex reference line 18 is extended rearward and perpendicular to the torso line 12 in such a manner that the end of the lumbar apex reference line 18 is substantially distant from the origin. This rearward lumbar apex reference line 18 is then used as a reference to establish the desired amount of lumbar support prominence. In order to achieve this, two lines perpendicularly related to the rearward lumbar apex reference line must be created.

The first perpendicularly related line, the rearward lumbar prominence line 20, extends between a rearward origin 22 and a rearward endpoint 24. The rearward origin 22 is located along the rearward lumbar apex reference line 18 at a specified distance forward of an intersection of a rearward surface 25 of the design manikin 14 and the rearward lumbar apex reference line 18. The rearward lumbar prominence line 20 extends from the rearward origin 22 in a relatively vertical sense parallel with the torso line 12 to the rearward endpoint 24, which is distant from the rearward origin 22.

The second perpendicularly related line, the forward lumbar prominence line 30, extends between a forward origin 32 and a forward endpoint 34. The forward origin 32 is located along the rearward lumbar apex reference line 18 at a specified distance forward of the rearward origin 22. The specified distance is representative of a total lumbar deflection desired. The forward lumbar prominence line 30 extends from the forward origin 32 in a relatively vertical sense, parallel with the torso line 12 to the forward endpoint 34 which is distant from the forward origin 32.

A lumbar shape reference circle 40 is then created having its center 42 located along the rearward lumbar apex reference line 18 and wherein the rearward lumbar prominence reference line 20 is tangent thereto. The radius of the lumbar shape reference circle 40 is representative of the desired shape of the lumbar support region and is determined based on anthropometric dimensions of the human body.

Determining the Overall Seat Back Shape with an Overall Centerline Contour

Using the rearward lumbar prominence reference line 20, an upper seat back contour transition reference point 50 is created along the rearward lumbar prominence reference line 20 a distance above the rearward origin 22 based on anthropometric landmarks of the human body. A lower seat back contour transition reference point 52 is created at the tangency location of the lumbar shape reference circle 40 and the forward lumbar prominence reference line 30. A transition shape 54 extending between the lower seat back contour transition reference point 52 and the upper seat back contour transition reference point 50 is created by means of a shaping function. The shaping function is a spline function. It should be appreciated by those skilled in the art that functions other than the spline function may be used without changing the scope of the invention. A lower seat back contour endpoint 60 is identified by an intersection of the lumbar shape reference circle 40 and a seat cushion contour 62, representing a contour of a seat cushion 63.

The centerline 15, which is used to determine the overall shape of the seat back 17, is identified as the shape extending from the lower seat back contour endpoint 60 generally vertically extending along the lumbar shape reference circle 40 to the lower seat back contour transition reference point 52, from the lower seat back transition reference point 52 along the transition shape 54, accomplished by means of the mathematical shaping function, to the upper seat back contour transition reference point 50, from the upper seat back contour transition reference point 50 along the rearward lumbar prominence line 20 to an upper seat back contour end point 66, determined by the required design height of the seat back 17, which can vary depending on the seat assembly 19 being designed.

Determining the Horizontal (Cross-Car) Seat Back Contours

The second main step of this method is the cross-car (horizontal) contour of the seat back 17. This is the relatively horizontal shape of the seat back 17 and is perpendicularly related to the centerline 15 at specific locations along the seat back 17. The specific locations of the specified cross-car contours are determined based on specific anthropometric landmarks of the human body. These have been translated to specific locations of the design manikin 14 to ensure a consistent design methodology. This design feature provides proper support to the occupant's back while not exerting excessive load onto the spinal processes (vertebral bodies of the spine). Minimizing load to these bodies improves both physical and perceived occupant comfort.

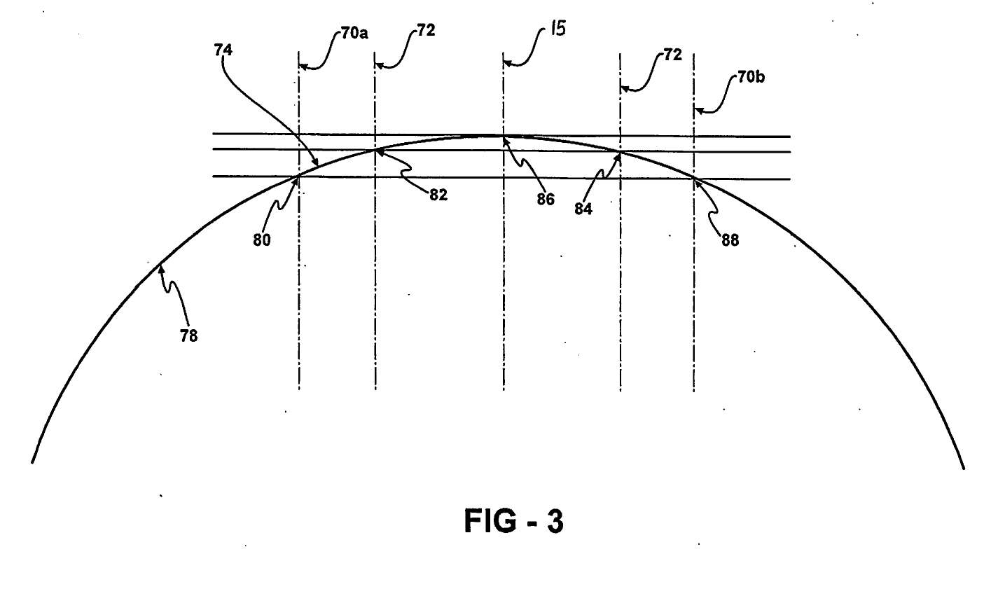

Referring to FIGS. 3-5, two copies of the centerline 15 are made. These two copies, are referred to as outer contour lines 70 (the first outer contour 70a and the second outer contour 70b, respectively) and are located horizontally outward and parallel to the centerline 15. The distance between each of the outer contour lines 70 and the centerline 64 is determined by the anthropometry of the human body. Each outer contour line 70 shall be adjusted perpendicularly forward of the torso line 12, such that each outer contour 70 is forward of the centerline 15. Two additional copies of the centerline 15 are constructed. These two copies are inner contour lines 72. The inner contour lines 72 are horizontally located outward and parallel to the centerline 15. The distance between the centerline 15 and each of the inner contour lines 72 is determined by the anthropometry of the human body. Each inner contour line 72 shall be forwardly adjusted along a line perpendicular to the torso line 12, such that it is forward of the centerline 15 and rearward of the outer contour lines 70.

Referring to FIG. 3, an apex horizontal contour 74 is constructed to define a portion of the horizontal contour. The apex horizontal contour 74 spans across the middle of the seat back 17. An apex contour point 76 located at the intersection of a plane perpendicular to the torso line 12 and containing the lumbar apex reference point 16 and the centerline 15 is constructed. Then, an apex circle 78 is constructed having a radius defined based on the anthropometry of the human body. The apex circle 78 resides in a plane that is perpendicular to the centerline 15, intersects each outer contour line 70, intersects each inner contour line 72, and contains the apex contour point 76. The apex horizontal contour 74 is the line having a first outer point 80 defined by the intersection of the apex circle 78 and the first outer contour 70a, intersection points 82 and 84 defined by the intersection of the apex circle 78 and each of the inner contour lines 72, a center point 86 defined by the intersection of the apex circle 74 and the centerline 15, and a second outer point 88 defined by the intersection of the apex circle 78 and the second outer contour 70b.

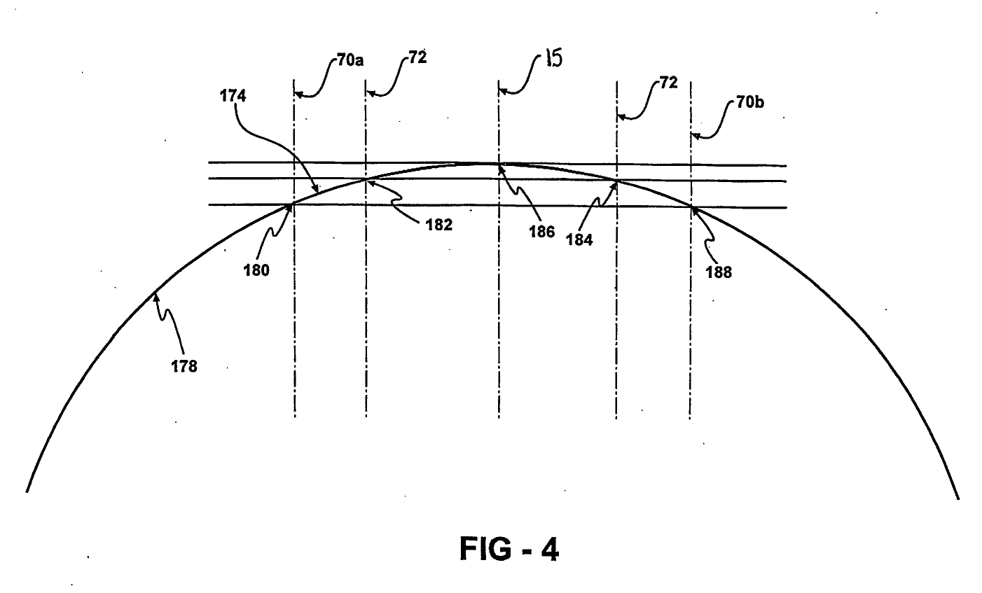

Referring to FIG. 4, a lower horizontal contour 174 is constructed to define a portion of the horizontal contour. A lower horizontal construction point 176 located at the intersection of a plane perpendicular to the design manikin torso line 12 and containing the design manikin Hpt 10 and the centerline 15 is constructed. Then, a lower circle 178 is constructed, having a radius one and half times the radius of the apex circle 78, and residing in a plane perpendicular to the centerline 15, intersects each outer contour line 70, intersects each inner contour line 72, and contains the lower horizontal construction point 176. The lower horizontal contour 174 is the line having a first outer point 180 defined by the intersection of the lower circle 178 and the first outer contour 70a, intersection points 182 and 184 defined by the intersection of the lower circle 178 and each of the inner contour lines 72, a center point 186 defined by the intersection of the lower circle 174 and the centerline 15, and a second outer point 188 defined by the intersection of the lower circle 178 and the second outer contour 70b.

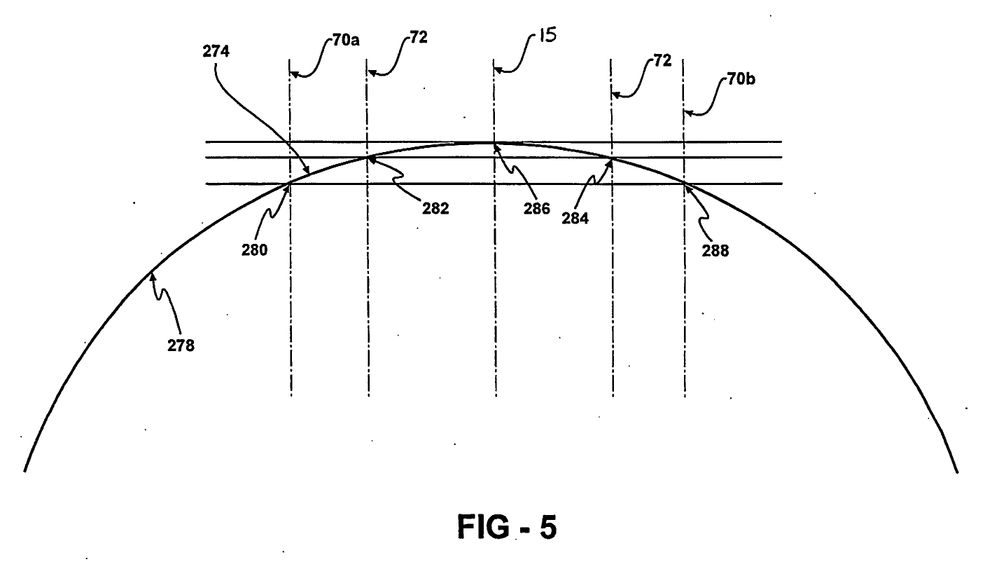

Referring to FIG. 5, an upper horizontal contour 274 is constructed to define a portion of the horizontal contour. An upper horizontal seat back contour reference point 90 located vertically above the lumbar apex reference point 16 at a desired distance based on the anthropometry of the human body is constructed. Then, an upper horizontal construction point 276 located at the intersection of a plane perpendicular to the torso line 12 and containing the upper horizontal seat back contour reference point 90 and the centerline 15 is constructed. Next, an upper circle 278 is constructed, having a radius twice the size of the radius of the apex circle 78. The upper circle 278 resides in a plane perpendicular to the centerline 15, intersecting each outer contour line 70 (adjusted 10 mm outward from the location when constructing the lower and apex horizontal contours), intersecting each inner contour line 72 (adjusted 10 mm outward from the location when constructing the lower and apex horizontal contours), and containing the upper horizontal construction point 276. The upper horizontal contour 274 is the line having a first outer point 280 defined by the intersection of the upper circle 278 and the first outer contour 70a, intersection points 282 and 284 defined by the intersection of the upper circle 278 and each of the inner contour lines 72, a center point 286 defined by the intersection of the upper circle 274 and the centerline 15, and a second outer point 288 defined by the intersection of the upper circle 278 and the second outer contour 70b.

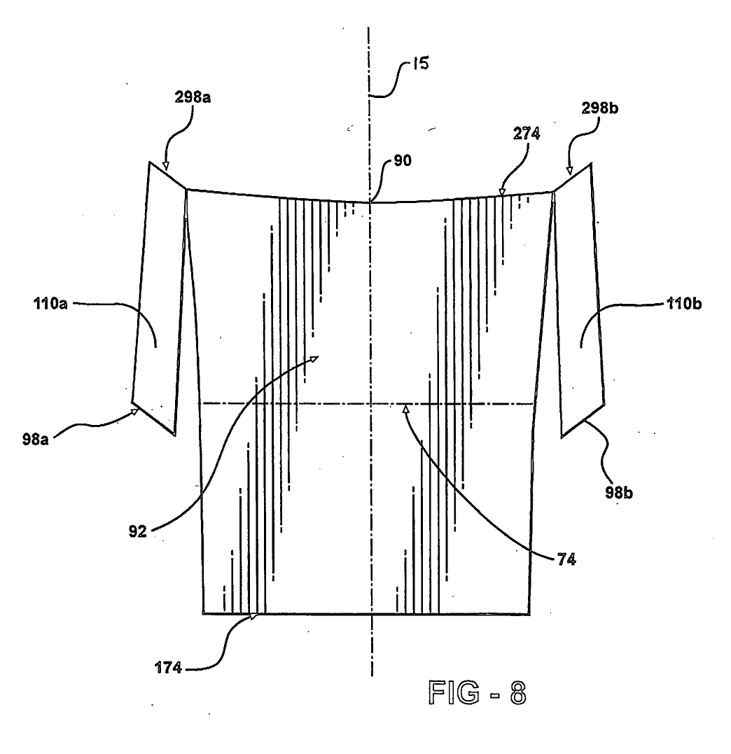

The overall seat back contour 92 as shown in FIG. 8, is defined by the shape resulting from connecting the outer points 180, 188 and the center point 184 of the lower horizontal contour 174 to the outer points 80, 88 and the center point 84 of the apex horizontal contour 74, respectively, by means of a mathematical shaping formula. The overall seat back contour 92 is further defined by the shape resulting from the surface connecting the outer points 80, 88 and center point 84 of the apex horizontal contour 74 to the outer points 280, 288 and the center point 284 of the upper horizontal contour 274, respectively, using the spline function, which includes a mathematical shaping formula. A mathematical shaping function is necessary to connect the contours into a single, consistent, smooth contour is necessary to connect the contours, as the shape will not be consistent.

Determining the Seat Back Bolster Contours

The final main step of this method is the bolster contours for the bolsters 96 of the seat back 17. The bolsters 96 are the relatively extended portions along the lateral edges of the seat back 17 designed to hold the occupant in the seat during cornering as well as to provide stabilizing support of the occupant during standard driving (straight driving). The shape of the bolster 96 is angularly related to the centerline contours at specific horizontal (width) locations. The proper placement in the horizontal direction as well as the proper angular relationship allows the seat back 17 to accommodate a full range of intended users.

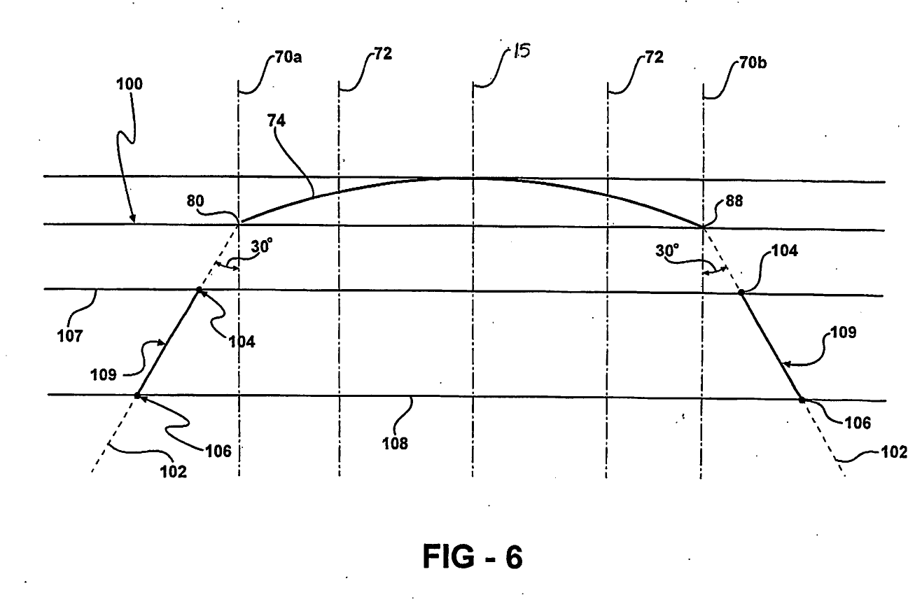

Referring to FIG. 6, apex bolster contours 98 are constructed to define a portion of the bolsters 96. First, an apex bolster line 100 is constructed by connecting the outer points 80, 88 of the apex horizontal contour 74. Then, apex bolster reference lines 102, lines having their origin at each outer point 80, 88 of the apex horizontal contour 74 and extending substantially forward and rotated outwardly 30 degrees from a respective pair of planes perpendicular to the apex bolster line 100 and containing the apex horizontal contour 74 are constructed. An inner apex bolster point 104 for each apex bolster contour 98 is defined by the intersection of the apex bolster reference line 102 and a first line 107 perpendicularly forward 60 mm and parallel to the apex bolster line 100. Next, an outer apex bolster point 106 for each apex bolster contour 98 is defined by the intersection of the apex bolster reference line 102 and a second line 108 perpendicularly forward 115 mm and parallel to the apex bolster line 100. The apex bolster contours 98, respectively inboard 98a and outboard 98b, are the segments 109 of each apex bolster reference line 102 extending between the inner apex bolster point 104 and the outer apex bolster point 106.

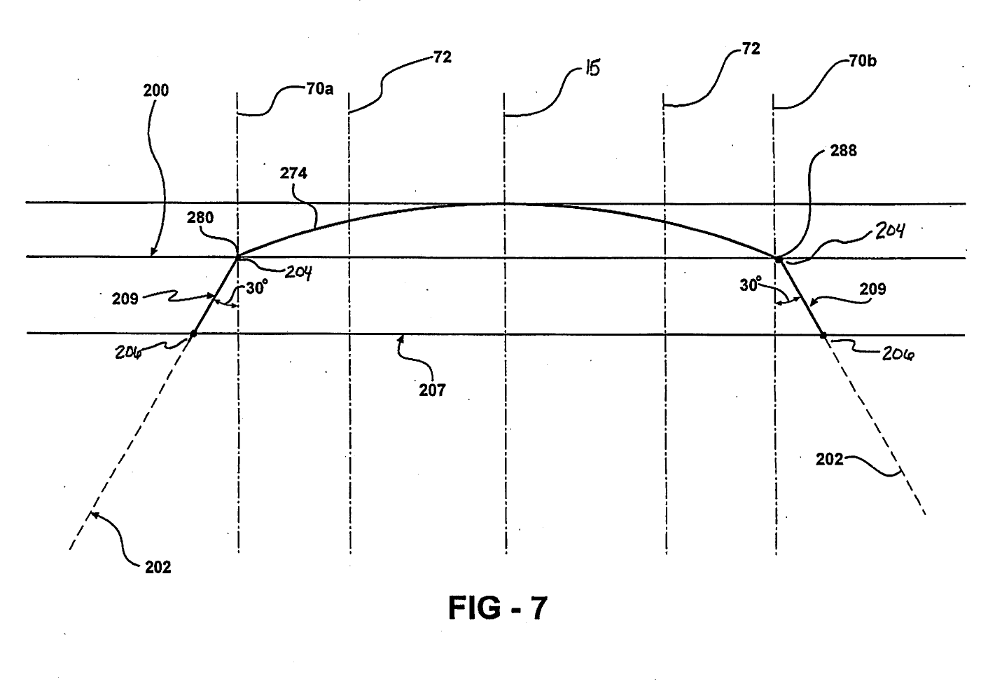

Referring to FIG. 7, upper bolster contours 298 are constructed to define a portion of the bolsters 96. First, an upper bolster line 200 is constructed between the outer points 280, 288 of the upper horizontal contour 274. Then, upper bolster reference lines 202, lines having their origin at each outer point 280, 288 of the upper horizontal contour 247 and extending substantially forward and rotated outwardly 30 degrees from a respective pair of planes perpendicular to the upper bolster line 200 and containing the upper horizontal contour 274, are constructed. An inner upper bolster point 204 for each upper bolster contour 298 is defined by the intersection of the upper bolster line 200 and the upper horizontal contour 274. Next, an outer upper bolster point 206 for each apex bolster contour 98 is defined by the intersection of the upper bolster reference line 202 and a third line 207 perpendicularly forward 60 mm and parallel to the upper bolster line 200. The upper bolster contours 298, respectively inboard 298a and outboard 298b, are the segments 209 of each upper bolster reference line 202 extending between the inner upper bolster point 104 and the outer upper bolster point 106.

Next, overall bolster contours 110, a pair of surfaces inboard 110a and outboard 110b respectively, are constructed by connecting the bolster points 204, 204 of the upper bolster contour 298 to the bolster points 104, 106 of the apex bolster contour 98, respectively, by means of a mathematical shaping formula. Each seat back bolster surface inboard 110a and outboard 110b, are located relatively in space such that they do not necessarily make contact with the overall seat back contour 92.

The invention has been described in an illustrative manner, and it is to be understood that the terminology that has been used, is intended to be in the nature of words of description rather than of limitation. Accordingly, any measurements used were for one particular application of the process and one skilled in the art will recognize that such measurements may be varied depending on the goals of the particular application.

Many modifications and variations of the present invention are possible in light of the above teachings. It is, therefore, to be understood that within the scope of the appended claims, the invention may be practiced other than as specifically described.

What is claimed is:

1. A method of designing a centerline for a seat back of a seat assembly using a design manikin having a hip point and a torso line, the method comprising the steps of:
defining a lumbar apex reference point above the hip point along the torso line;
defining a lumbar shape reference circle behind the torso line and spaced apart therefrom;
creating a forward lumbar prominence line parallel to the torso line and tangential to the lumbar shape reference circle;
creating a rearward lumbar prominence line parallel to the forward lumbar prominence line and spaced rearward therefrom; and
shaping a centerline for the seat back incorporating the forward and rearward lumbar prominence lines and the lumbar shape reference circle.

2. A method as set forth in claim 1 further including the step of creating a rearward lumbar apex reference line extending rearward from the lumbar apex reference point to a point perpendicular to and distant from the torso line.

3. A method as set forth in claim 2 including the step of creating a lumbar shape reference circle having a center located along the rearward lumbar apex reference line.

4. A method as set forth in claim 3 wherein the step of creating the forward lumbar prominence line includes the step of positioning the forward lumbar prominence line tangentially with the lumbar shape reference circle.

5. A method as set forth in claim 4 including the step of orienting the rearward lumbar prominence line perpendicular to the rearward lumbar apex reference line wherein the rearward lumbar prominence line and the rearward lumbar apex reference line intersect at an interior point interior of the lumbar shape reference circle.

6. A method as set forth in claim 5 further including the step of defining a seat cushion contour intersecting the lumbar shape reference circle below the hip point.

7. A method as set forth in claim 6 wherein the step of shaping the centerline includes the step of extending the centerline along the lumbar shape reference circle near the seat cushion contour.

8. A method as set forth in claim 7 wherein the step of shaping the centerline further includes the step of influencing the centerline with the lumbar shape reference circle and the rearward lumbar prominence line at a first location defined by a first intersection of the lumbar shape reference and the rearward lumbar prominence line.

9. A method as set forth in claim 8 wherein the step of shaping the centerline also includes the step of influencing the centerline with the lumbar shape reference circle and the seat cushion contour at a second location defined by a second intersection of the lumbar shape reference circle and the seat cushion contour.

10. A method as set forth in claim 9 wherein the step of shaping the centerline further includes the step of extending the centerline substantially along the rearward lumbar prominence line to a centerline end point at a final location spaced apart from and above the lumbar shape reference circle.

11. A method for shaping a seat back of a seat assembly having a seat back face and two side bolsters using a design manikin having a hip point and a torso line, the method comprising the steps of:
defining a lumbar apex reference point above the hip point along the torso line;
defining an apex circle, having an apex circle radius perpendicular to the torso line and containing the lumbar apex reference point;
defining an apex centerline for shaping an apex central portion of the seat back face;
positioning the apex centerline such that it abuts the apex circle, the apex centerline defining a contour profile;
defining outer apex contour lines for shaping portions of the seat back face spaced from the central portion and having contour profiles equal to the apex centerline contour profile; and
positioning outer apex contour lines on either side of the apex centerline parallel thereto and intersecting the apex circle equidistantly from the apex centerline.

12. A method as set forth in claim 11 further including the step of defining inner apex contour lines having contour profiles equal to the apex centerline contour profile.

13. A method as set forth in claim 12 further including the step of positioning the inner apex contour lines on either side of the apex centerline along the apex circle parallel to the apex centerline.

14. A method as set forth in claim 13 further including the step of placing the inner apex contour lines between the apex centerline and the outer apex contour lines.

15. A method as set forth in claim 14 further including the step of shaping an apex horizontal contour incorporating a portion of the apex circle.

16. A method as set forth in claim 15 including the step of defining the portion of the apex circle as extending between the apex contour lines.

17. A method as set forth in claim 16 further including the step of defining a lower circle perpendicular to the torso line containing the hip point and having a lower circle radius greater than the apex circle radius.

18. A method as set forth in claim 17 further including the step of defining a lower centerline for shaping a lower central portion of the seat back face.

19. A method as set forth in claim 18 further including the step of positioning the lower centerline such that it intersects the lower circle, the lower centerline defining a lower contour profile.

20. A method as set forth in claim 19 further including the step of defining outer lower contour lines for shaping portions of the seat back face having lower contour profiles equal to the lower centerline contour profile.

21. A method as set forth in claim 20 further including the step of positioning outer lower contour lines on either side of the lower centerline and intersecting the lower circle equidistantly from the lower centerline.

22. A method as set forth in claim 21 including the step of defining inner lower contour lines having lower contour profiles equal to the lower centerline contour profile.

23. A method as set forth in claim 22 including the step of positioning the inner lower contour lines on either side of the lower centerline along the lower circle parallel to the lower centerline.

24. A method as set forth in claim 23 including the step of shaping a lower horizontal contour incorporating a portion of the lower circle.

25. A method as set forth in claim 24 including the step of defining the portion of the lower circle as extending between the lower contour lines.

26. A method as set forth in claim 25 further including the step of defining an upper circle perpendicular to the torso line vertically above the lumbar apex reference point and having an upper circle radius greater than the lower circle radius.

27. A method as set forth in claim 26 further including the step of defining an upper centerline for shaping an upper central portion of the seat back face.

28. A method as set forth in claim 27 further including the step of positioning the upper centerline such that it intersects the upper circle, the upper centerline defining an upper contour profile.

29. A method as set forth in claim 28 further including the step of defining outer upper contour lines for shaping portions of the seat back face having upper contour profiles equal to the upper centerline contour profile.

30. A method as set forth in claim 29 further including the step of positioning outer upper contour lines on either side of the upper centerline and intersecting the upper circle equidistantly from the upper centerline.

31. A method as set forth in claim 30 including the step of defining inner upper contour lines having upper contour profiles equal to the upper centerline contour profile.

32. A method as set forth in claim 31 including the step of positioning the inner upper contour lines on either side of the upper centerline along the upper circle parallel to the upper centerline.

33. A method as set forth in claim 32 including the step of shaping an upper horizontal contour incorporating a portion of the upper circle.

34. A method as set forth in claim 33 including the step of defining the portion of the upper circle as extending between the upper contour lines.

35. A method as set forth in claim 34 including the step of joining a first lower point defined by a first lower intersection of the lower horizontal contour and an outer lower contour to a first apex point defined by a first apex intersection of the apex horizontal contour and an outer apex contour, a second lower point defined by a second lower intersection of the lower horizontal contour and the lower centerline to a second apex point defined by a second apex intersection of the apex horizontal contour and the apex centerline, and a third lower point defined by a third lower intersection of the lower horizontal contour and an outer lower contour to a third apex point defined by a third apex intersection of the apex horizontal contour and an outer apex contour, to define an overall seatback contour.

36. A method as set forth in claim 35 further including the step of joining the first apex point to a first upper point defined by a first upper intersection of the upper horizontal contour and an outer upper contour, the second apex point to a second upper point defined by a second upper, intersection of the upper horizontal contour and the upper centerline, and the third apex point to a third upper point defined by a third upper intersection of the upper horizontal contour and an outer upper contour, to further define the overall seatback contour.

37. A method as set forth in claim 36 wherein the outer apex contour lines, the outer lower contour lines, and the outer upper contour lines define the width of the portion of the seat back face.

38. A method as set forth in claim 37 including the step of shaping an overall horizontal contour incorporating the apex and lower and upper horizontal contours thereby defining a surface of a portion of the seat back face.

39. A method as set forth in claim 38 including the step of creating an apex bolster line extending between the intersection of the outer apex contour lines and the apex horizontal contour.

40. A method as set forth in claim 39 including the step of creating apex bolster reference lines extending angularly forward from an intersection of the outer apex contour lines and the apex horizontal contour in a plane perpendicular to the apex bolster line and containing the apex horizontal contour.

41. A method as set forth in claim 40 further including the step of creating a first line parallel to the apex bolster line and spaced forwardly therefrom.

42. A method as set forth in claim 41 further including the step of creating a second line parallel to the first line and spaced forwardly therefrom.

43. A method as set forth in claim 42 further including the step of shaping the apex bolster contours incorporating a portion of the apex bolster reference lines.

44. A method as set forth in claim 43 including the step of defining the portion of the apex bolster reference lines as extending between the intersection of the apex bolster reference lines and the first line and the intersection of the apex bolster reference lines and the second line.

45. A method as set forth in claim 44 including the step of creating an upper bolster line extending between the intersection of the outer upper contour lines and the upper horizontal contour.

46. A method as set forth in claim 45 including the step of creating upper bolster reference lines extending angularly forward from the intersection of the outer upper contour lines and the upper horizontal contour in a plane perpendicular to the upper bolster line and containing the upper horizontal contour.

47. A method as set forth in claim 46 further including the step of creating a third line parallel to the upper bolster line and spaced forwardly therefrom.

48. A method as set forth in claim 47 further including the step of shaping the upper bolster contours incorporating a portion of the upper bolster reference lines.

49. A method as set forth in claim 48 including the step of defining the portion of the upper bolster reference lines as extending between the intersection of the upper bolster line and the upper horizontal contour and the intersection of the upper bolster reference line and the third line.

50. A method as set forth in claim 49 including the step of shaping an overall bolster contour incorporating the apex and upper bolster contours thereby defining a surface of a portion of the two side bolsters.

51. A method as set forth in claim 50 including the step of incorporating the overall bolster contour into the shaping of the overall seatback contour.
